(19) United States
(12) Patent Application Publication
(10) Pub. No.: US 2019/0279535 A1
(43) Pub. Date: Sep. 12, 2019

(54) Decoration and Identification Device for Stemware

(71) Applicant: Stacey Eve Sartena, Smithtown, NY (US)

(72) Inventor: Stacey Eve Sartena, Smithtown, NY (US)

(21) Appl. No.: 16/272,609

(22) Filed: Feb. 11, 2019

Related U.S. Application Data
(60) Provisional application No. 62/639,265, filed on Mar. 6, 2018.

(51) Int. Cl. G09F 3/02; A47G 19/22

(52) U.S. Cl. CPC G09F 3/02; G09F 2003/0251; A47G 2019/2238; A47G 19/2227

(57) ABSTRACT

A device for the identification or decoration of stemware. A tubular sleeve of plastic is slit longitudinally on its back side. The sleeve ends are contoured at an angle to the sleeve axis, extending axially inward from the front side, to form a V-shaped end configuration with the convergent end of the “V” aligned with the slit. The device is applied by engaging the stem with a contoured end and pressing toward the stem to cam open the back side of the sleeve and allow it to close around the stem. A rubbery friction pad may be adhered to the inside of the sleeve, near the bottom, to minimize movement of the sleeve on the stem. Identifying and/or decorating embellishments may be applied to the sleeves for distinguishing stemware of similar appearance, or each device of a set may be provided with the same decoration, such as a corporate logo.

### FIELD OF THE INVENTION

The invention relates to a simple and inexpensive device for decorating and/or identifying stemware at parties and other gatherings where beverages, typically wines, are served in long-stemmed glassware.

### BACKGROUND OF THE INVENTION

It is a common practice at festive gatherings that many people will be served similar, or at least similar looking, beverages in long stemmed glasses that are the same or look very similar. A problem arises when two or more persons put their glasses down temporarily. If their attention becomes even a little distracted, as by conversation with another person or other action at the event, it often is very difficult to identify with certainty which of several similar-looking glasses with similar-looking beverages belongs to whom. It is not uncommon in such circumstances for a person to simply abandon a partly consumed beverage rather than pick up a glass that might have been used by another person. This problem has resulted in a market for devices that can be attached to stemware to serve as a personal identifier, such that, while the glasses may look the same, the identifiers are differentiated by color, shape, adornments, and/or other means enabling the individual users to easily determine his or her glass from a plurality thereof.

In the prior art, the David et al. U.S. Pat. No. 5,339,549 discloses a split plastic ring that can be attached to the handle of a cup. The Skapyak at al. U.S. Pat. No. 6,293,034 shows spring steel rings with identifying decorations that can be applied over the stem of a wine glass. Holmes et al. U.S. Pat. No. 6,741,150 shows an identification ring provided with a magnetic coupling for placement around the stem of a wine glass. The Agarwal et al design patent D715,591 shows a form of helix that can be applied around the stem of a wine glass for identification purposes. All of the foregoing concepts have one or more shortcomings that are addressed by the present invention, which provides more economical, more flexible and more useful solutions.

### SUMMARY OF THE INVENTION

The present invention is directed to a novel and improved device that can be applied to and removed from stemware with greater facility than existing products, and which can be easily and inexpensively embellished with identifying and/or decorating material. The low cost of the device also makes it suitable for single use, where appropriate, making it also desirable for special occasions, such as weddings, corporate parties, and the like. If desired, individual devices can be embellished with jewelry or other more costly décor that could be repeatedly used.

In its most basic aspect, the invention comprises a short sleeve of plastic or plastic-like tubing, which is slit axially from end to end. The sleeve is formed of a material, such as polyvinyl chloride (pvc), and is relatively stiff along its axis but has sufficient elasticity to enable the slit sleeve to be opened enough to be applied over the stem of a wine glass or the like. At least one end of the sleeve, and preferably both ends, is or are provided with a V-shaped edge transitioning from the end extremity of the closed or front side of the sleeve to the axial slit on the opposite or back side thereof. This configuration enables the sleeve to be applied to the stem of a glass by simply placing the V-shaped entrance to the slit against the stem and pressing the device laterally toward the stem and slightly downward. The slit is easily cammed open by the glass stem, allowing the open side of the sleeve to pass over the stem and to elastically close on the opposite side thereof. The device will remain reliably attached until intentionally removed.

In a preferred embodiment of the invention, a friction pad of a soft, rubbery material is mounted on the inside of the sleeve adjacent to the V-shaped opening at the bottom of the sleeve. The friction pad enables the sleeve to fit better on small stems and also inhibits movement of the sleeve on the stem.

The device of the invention can be used to enhance a table setting for a meal or an event (weddings, anniversaries, etc.). For example, each different type of glass at each table setting may be provided with a different décor: the glasses for white wine may have white roses, the glasses for red wine may have baby breath, and the champagne glasses may have crystals hanging from them. This will enhance the table décor while serving as a way to distinguish between the different glasses at the table, and also help an individual distinguish between his or her own different glasses.

The invention is also useful for a table that might not have adequate room for a centerpiece or décor. In such cases the décor is incorporated into the glasses that are a necessary part of the table setting, freeing up considerable room on the table.

In addition, one can attach a photo (a memory) to the stem, which not only serves to distinguish one glass from another but also can serve to create a display of memories and keepsake photos on the stemware, when storing the glasses on display.

The tubular sleeve can be fully surrounded and covered by embellishments of any material, transforming the stem to look like the embellishment is an integral part of the glass, as if originally made that way. This enables one to transform any stemmed glass to appear to be a different glass than it originally was.

The device of the invention can have attached embellishments that extend above or below the plastic sleeve, e.g., flowers with leaves higher and/or lower than sleeve, making the embellished device much larger than the sleeve by which it is attached. The device can also have charms or ornaments dangling from it or dangling from an embellishment attached to it, which can give the illusion of jewelry.

The embellishment can also be in the form of an LED candle controlled locally by an on-board switch or remotely, the latter allowing for all such candles to be turned on or off simultaneously. This ads to the ambiance of a table without the safety-concerns from the flames of actual candles. This also enables saving of space on the table that might not have room for actual candles or décor, by incorporating the candle with the glasses that are a necessary part of the table setting.

For a more complete understanding of the above and other features and advantages of the invention, reference should be made to the following detailed description of preferred embodiments thereof and to the accompanying drawings.

### BRIEF DESCRIPTION OF THE DRAWINGS

FIG. 1 is a back elevational view of the device of the invention, in an elemental form thereof, showing the sleeve in a normal, closed configuration.

FIG. 2 is a side elevational view showing the device in initial stages of being applied over the stem of a wine glass or the like.

FIG. 3 is a back elevational view showing the device as fully applied to the stem of a glass.

FIG. 4 is an elevational view, partly from the front and partly from the side, showing the manner of removing the device from a glassware stem.

FIG. 5 is a back elevational view of a device according to the invention, having a decorative embellishment mounted on its front.

FIG. 6 is an orthographic view of a device according to the invention embellished with an LED candle and other features.

### DESCRIPTION OF PREFERRED EMBODIMENTS

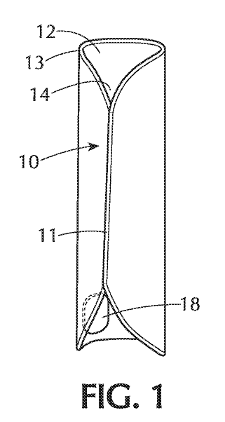

Referring initially to FIG. 1, the basic device of the invention comprises a tubular sleeve 10, formed of a relatively stiff plastic material, such as polyvinylchloride (pvc). Although specific dimensions are not critical, an advantageous embodiment of the invention may be about 2 inches in length, with a circular cross section at a diameter of about one quarter inch to one-half inch. A typical wall thickness may be about 1/64th of an inch. The tubular sleeve 10 is slit longitudinally on one side only (designated herein as the back side), as indicated at 11. The thickness of the material and the inherent stiffness of its cylindrical form is such that the tubular sleeve 10 is not easily bendable along its axis but can be flexed in the cross section so that the slit 11 can be opened and will tend to close by the inherent elasticity of the material. Typically, the slit 11 is formed by a single narrow cut, such that normally the edges of the slit are in contact, or nearly so, or possibly even slightly overlapped. In appropriate cases, the slit may be wider, although in all cases the slit 11 must be sufficiently narrower than the diameter of the glassware stem for which it is intended that the tubular sleeve 10 can partially close around the back side of the stem of a glass and be reliably retained thereon. It is to be noted that reference herein to glassware, glass, glasses or the like is not intended to be limiting as to the usage of the invention. Stemware is often made in plastic as well as glass and other materials, and the invention is applicable to all such forms of stemware

The material of the tubular sleeve 10 advantageously is clear and transparent, although it may be colored. Pursuant to the invention, the sleeve 10 is embellished with a decorative and/or identifying feature, several types of which will be described hereinafter, Ideally, when the sleeve 10 is mounted on the stem of a glass, the transparency of the sleeve will cause it to blend in with the stem and give the appearance that the embellishment is an integral part of the stem.

Importantly, at least one end of the sleeve 10, and preferably both ends, is or are formed with an axially convergent edge configuration formed by cutting away back corner areas, formed by the slit 11 and the end surfaces 12 of the tubular sleeve. The convergent configuration of the edges preferably commences from a front region 13, located diametrically opposite to the slit 11, and extends circumferentially and axially toward the slit 11 to form a contoured, angled opening 14 of V-shaped configuration in the back, leading symmetrically to the slit 11. Preferably, the axial length of the V-shaped opening is less than the diameter of the sleeve. Thus, for a sleeve of one-half inch diameter, the V-shaped opening 14 may extend for an axial distance of, for example, about ⅜th inch. Preferably the contours of the V-shaped opening 14 are relatively flat (i.e., transverse to the sleeve axis) at the front of the sleeve and become progressively steeper and more axially disposed as the contoured edges approach and merge with the longitudinal slit 11. In a desirable embodiment of the invention, the contours of the end edges of the sleeve are relatively flat for slightly less than half of the circumference of the sleeve, commencing at a point directly opposite to the slit 11, after which the edges angle progressively more steeply until smoothly merging with the edges of the slit. The contours of the V-shaped opening 14 perform an important function in facilitating mounting of the sleeve 10 on the stem of a glass by enabling the sleeve to be easily caromed open by the stem of a glass during mounting of the sleeve.

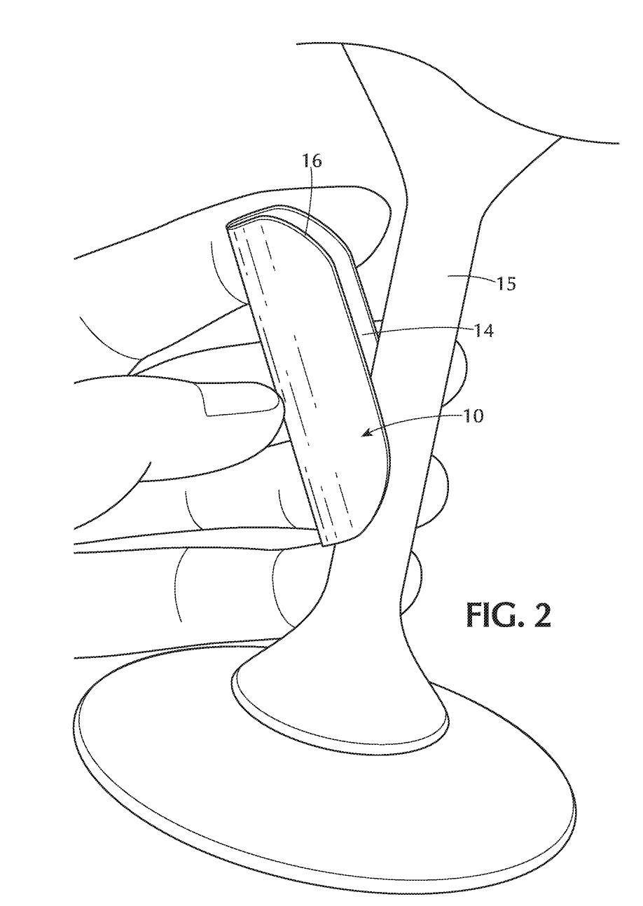

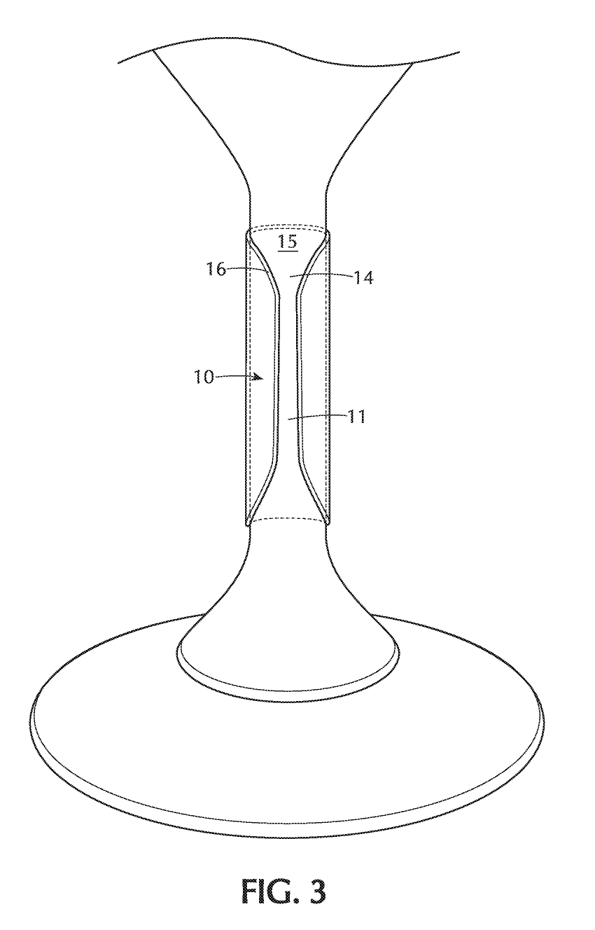

The sleeve 10 can be mounted on the stem 15 of a wine glass or the like by placing the edges of a V-shaped opening 14 against the stem 15 of the glass, as shown in FIG. 2. The sleeve 10 will naturally tend to line itself up such that the axis of the sleeve 10 lies in a common plane with the axis of the stem 15 but at an angle thereto, with the side edges 16 of the V-shaped opening 14 engaging the stem 15 on opposite sides. The user can then press inwardly and slightly downward on the front of the sleeve, as indicated in FIG. 2. This will cause the edges 16 of the opening to be spread apart by the circular contours of the stem 15, allowing the sleeve to progressively envelop the stem. Once beyond the maximum diameter of the stem, the sleeve closes elastically around the opposite side, as shown in FIG. 3. The mounting actions are simple and are quickly and easily accomplished. No particular skill or dexterity is required.

In the device shown in FIG. 3, the internal diameter of the sleeve 10 is slightly less than the diameter of the stem 15, such that the installed tubular sleeve snugly grips the stem 15. For smaller stems, or with tubular sleeves of larger diameter, the tubular sleeve 10 may fit more loosely on the stem 15, allowing a narrow slit to fully close. Thus a sleeve 10 of given diameter can be installed and used on stemware of a variety of sizes, with stems of various diameters, both larger and smaller than the natural internal diameter of the sleeve.

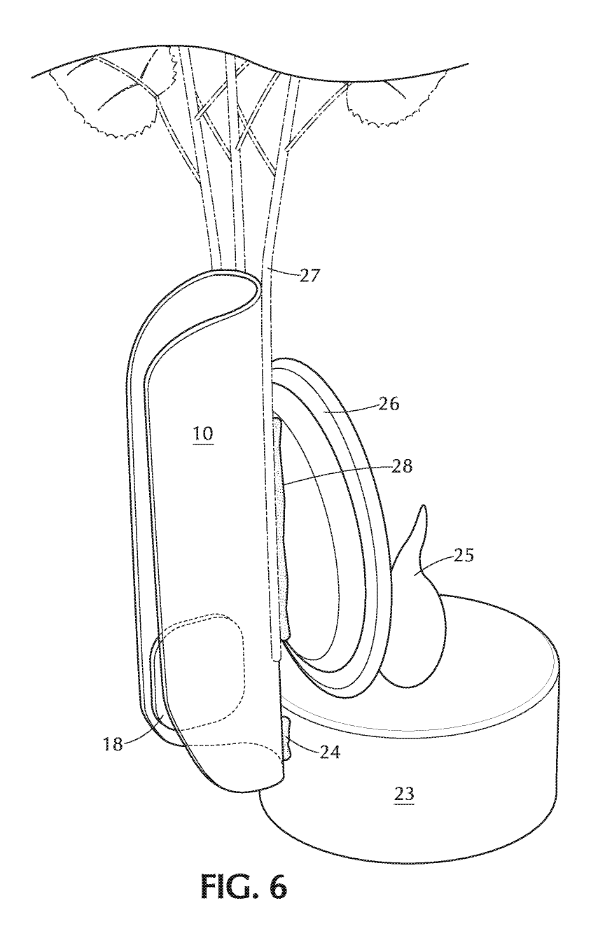

To particular advantage, a small friction pad 18 is attached to the inside of the tubular sleeve 10, preferably near the bottom end thereof, as shown in FIGS. 1 and 6. A preferred form of friction pad 18 is in the nature of a circular disc of a soft, rubbery material. The disc may have a thickness of about 1/16th inch and a diameter of about one-half inch. Preferably, the material of the disc is transparent or translucent so as to be inconspicuous within the sleeve 10. Advantageously, the friction pad 18 is provided with a suitable contact adhesive on one surface thereof so as to be easily adhered to an inside surface of the sleeve. When the sleeve 10 is mounted on the stem of a glass, the friction pad 18 will engage with the stem and tend to limit motion of the sleeve relative to the stem. Also, where a glass stem is of smaller diameter than that of the sleeve 10, the friction pad often will be able to engage the surface of the stem, especially near the base, where the stem may flare out somewhat to a slightly larger diameter. The presence of the friction pad 18 thus enables a given size of sleeve 10 to function in an optimum manner with a wide range of stem sizes.

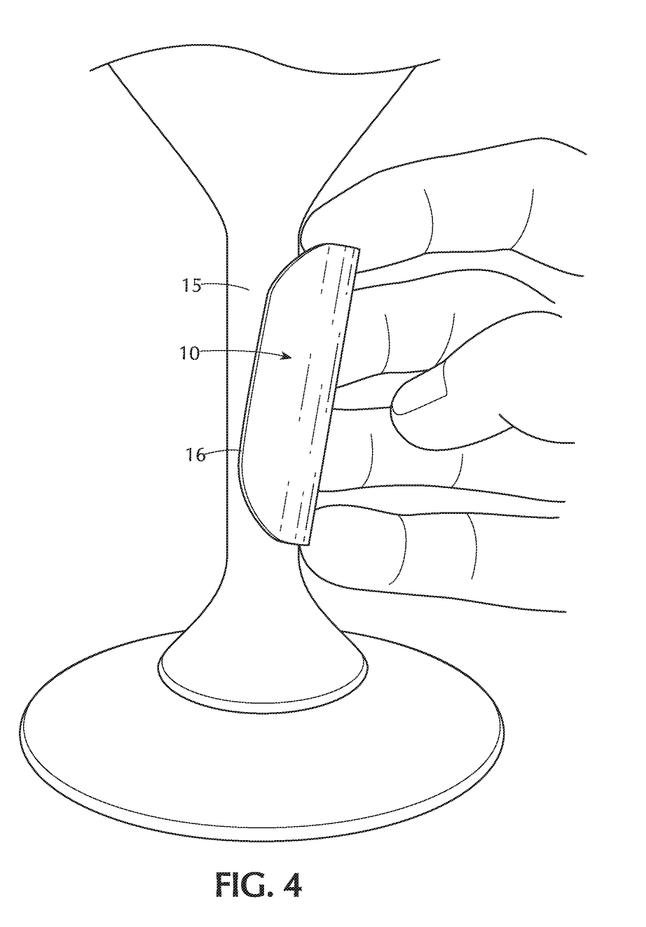

Removal of the device, when desired, is illustrated in FIG. 4. The top or bottom of the sleeve 10 is engaged by a fingertip and drawn outwardly from the stem 15. The V-shaped opening 14 works in reverse during removal, progressively camming open the opposite edges 16 of the sleeve 10. Once the edges 16 are opened to the diameter of the stem 15, the device may be gripped and removed. As with the installation, removal is very quick and very easy and requires no special skill or dexterity.

For a purely identifying function, the device of the invention may be made of a colored plastic, for example, with each sleeve of a set having a different color. Or the tubular sleeves may be provided with other distinguishing features, such as stripes varying in color and/or number. There are of course endless ways in which individual devices may be differentiated.

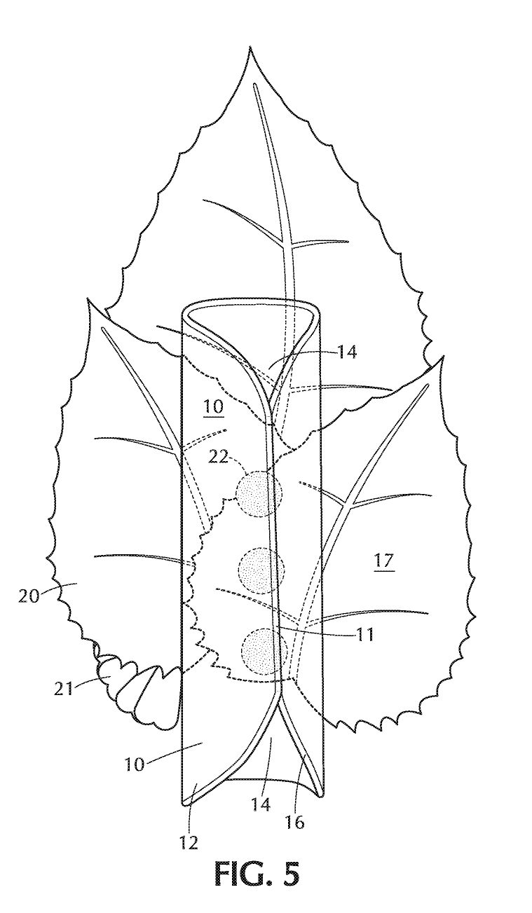

In FIG. 5 there is shown one of many possible forms of embellishments 17, which can be differentiated from each other to enable individual glasses to be identified to their users, or which may be made the same for all glasses so as to represent a hosting party or organization, for example a wedding or corporate function. In FIG. 5, the embellishment 17 comprises an artificial floral device 19 consisting of artificial leaves 20 at the back and an artificial flower 21 at the front. This decoration is mounted on the sleeve 10 by a suitable, preferably clear adhesive 22. As an alternative, leaves or other elements of the floral device 19 may be wrapped completely around the sleeve 10 such that, when the sleeve is mounted on a stem 15 the floral device tends to have the appearance of being a part of the stem rather than an attachment thereto.

FIG. 6 illustrates another representative form of the invention in which a small, lightweight LED candle 23 is attached to a bottom portion of the sleeve 10 by an adhesive 24. The candle 23, which includes an illuminated “flame” 25, may also be associated with a decorative panel 26 and an artificial floral piece 27, also secured to the sleeve 10 by adhesive 28. LED candles are readily available with either local control (i.e., a switch on the device) or remotely, wirelessly controlled. In the latter case, all of the candles at all of the tables or selected tables may be lighted and extinguished simultaneously for a desired effect. The mounting of LED candles on the existing table stemware, as enabled by the invention, has an important advantage in freeing up a significant area of the table for food service and/or other decorative features. There is also second and important safety advantage in the use of LED candles in place of ordinary flame candles to achieve a desired ambiance.

A particularly desirable form of embellishment is a photo, suitable to the occasion. The photo may be encapsulated in clear plastic and adhesively mounted on the sleeve. To advantage, the photo can be in the form of a cut-out, for example, of a person or persons relevant to the event. Such photos can be later displayed, mounted on the stemware, individually or in a collection.

Sleeves 10, carrying three dimensional embellishments thereon, are mounted on and removed from stemware in same manner as indicated in FIGS. 2 and 4. The nature and mounting of the embellishments on the tubular sleeves 10 is such as to provide access to the top and/or bottom extremities of the sleeves 10 for mounting and removal thereof from stemware.

The device of the invention is particularly unique in its ease of mounting and removal from stemware. It can also be produced at a very low cost, so as to be realistically capable of use on a disposable, single use basis. It also can be adorned with items of more value, such as jewelry, where the devices are intended to be reusable.

It should be understood that the particular embodiments of the invention herein illustrated and described are intended to be representative of the invention and not in any way in limitation thereof. Accordingly, reference should be made to the following appended claims in determining the full scope of the invention.

What is claimed is:

1. A device for the identification and/or decoration of stemware, which comprises
a tubular sleeve of plastic material,
said sleeve having a length greater than a diameter thereof and having a longitudinal slit on one side thereof over the full length of said one side,
at least one end of said sleeve being contoured at an angle to an axis thereof and symmetrically with respect to said longitudinal slit to form end edges of V-shaped configuration,
said V-shaped configuration having a convergent end and said convergent end being located at an end of said longitudinal slit,
said sleeve having mounted thereon an embellishment with identifying and or decorative characteristics,
said device being applied to a stemware item by initially engaging the stem thereof with a contoured end of said sleeve, with the longitudinal axis of said sleeve being disposed at an angle to an axis of the stem, and pressing inward on said contoured end to cam the sleeve open and cause it to envelop the stem.

2. A device according to claim 1, wherein
said sleeve is formed with a contoured V-shaped end configuration at both ends thereof.

3. A device according to claim 1 wherein
said device has a front side opposite to said slit and a back side including said slit,
the end edges of said contoured end configuration are initially disposed at a large angle to a longitudinal axis of said sleeve from a point on said front side directly opposite to said slit and extending circumferentially in opposite directions from said point for a first distance,
said end edges thereafter extending circumferentially at a progressively smaller angle relative to said longitudinal axis until merging with said slit.

4. A device according to claim 1, wherein
said embellishment is mounted on a front side of said device, opposite to said slit.

5. A device according to claim 1, wherein
said embellishment substantially surrounds said device and a stem on which said device is mounted.

6. A device according to claim 1, wherein
said embellishment comprises an LED artificial candle,
said candle being controllably alternatively locally or remotely.

7. A device according to claim 1, wherein
said embellishment comprises a photograph.

8. A set consisting of a plurality of devices according to claim 1, wherein
the embellishment for each of the devices includes a distinctly different identifying information.

9. A set consisting of a plurality of devices according to claim 1, wherein
the embellishment for each of the devices of the set comprises the same decorative feature.

10. A device according to claim 1, wherein
a friction pad of soft, rubbery material is attached to an inner wall of said tubular sleeve, adjacent to a lower end thereof, for frictional engagement with the stem of a glass.

11. A device according to claim 10, wherein
said friction pad is in the form of a thin, clear, flexible element having a contact adhesive on one side for attachment to an inner wall of said tubular sleeve.

12. A device according to claim 11, wherein
said friction pad is in the form of a disc of smaller diameter than said tubular sleeve.
